(19) United States
(12) Patent Application Publication
(10) Pub. No.: US 2008/0180205 A1
(43) Pub. Date: Jul. 31, 2008

(54) TRANSFORMER STRUCTURE

(75) Inventors: Sheng-Nan Tsai, Taoyuan Hsien (TW); Tian-Chang Lin, Taoyuan Hsien (TW); Kang-Yu Fan, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 11/751,270

(22) Filed: May 21, 2007

(30) Foreign Application Priority Data
Jan. 31, 2007 (TW) 096103606

(51) Int. Cl. H01F 27/29

(52) U.S. Cl. 336/192

(57) ABSTRACT

A transformer includes a primary winding coil, a plurality of conductive pieces, a bobbin and a magnetic core assembly. The bobbin includes a plurality of hollow partition plates and a wall portion. The wall portion is arranged between every two adjacent hollow partition plates to form a channel and a winding section for being wound the primary winding coil thereon. The hollow partition plates have respective receiving portions for accommodating the conductive pieces therein. The magnetic core assembly is partially embedded within the channel.

### FIELD OF THE INVENTION

The present invention relates to a transformer, and more particularly to a transformer which is easily assembled.

### BACKGROUND OF THE INVENTION

A transformer has become an essential electronic component for voltage regulation into required voltages for various kinds of electric appliances. Referring to FIG. 1(a), a schematic exploded view of a conventional transformer is illustrated. The transformer 100 principally comprises a bobbin 110, a magnetic core assembly 130, multiple ring-shaped conductive pieces 150, an insulating coil 170 and a retaining rod 190. The bobbin 110 includes a base 113 and a cylinder 115. The cylinder 115 is disposed on the base 113, and includes a channel 115c therein. The magnetic core assembly 130 is partially embedded into the channel 115c. In addition, multiple ribs 115a are discretely arranged at regular intervals on the external surface of the cylinder 115 such that fixing recesses 111 are defined between every two adjacent ribs 115a. The ring-shaped conductive pieces 150 are received within corresponding fixing recesses 111.

Each ring-shaped conductive piece 150 includes a main body 151 and a protrusion portion 153. The inner periphery of the ring-shaped conductive piece 150 includes several first notches 151a. The number, the size and the location of the first notches 151a are fitted to those of the corresponding ribs 115a.

Hereinafter, a process of assembling the transformer 100 will be illustrated as follows. First of all, the first notches 151a of the ring-shaped conductive pieces 150 are aligned with corresponding ribs 115a of the cylinder 115 and then the ring-shaped conductive pieces 150 are sheathed around the cylinder 115. Once the ring-shaped conductive pieces 150 are received in the fixing recesses 111, the ring-shaped conductive pieces 150 are rotated by a specific angle such that the ring-shaped conductive pieces 150 are fixed in the fixing recesses 111 of the cylinder 115. Then, the retaining rod 190 is inserted into second notches 151b of the ring-shaped conductive pieces 150 and an elongated passage 115b of the cylinder 115. Accordingly, the ring-shaped conductive pieces 150 are positioned on the bobbin 110 and parallel to each other. Subsequently, the insulating coil 170 is sheathed around the cylinder 115 and between every two adjacent ring-shaped conductive pieces 150. After the magnetic core assembly 130 is embedded into the channel 115c, the transformer 100 is assembled.

The structure and the assembling process of the above transformer 100 still have some drawbacks. For example, the first notches 151a of the ring-shaped conductive pieces 150 needs to be precisely aligned with corresponding ribs 115a of the cylinder 115. In addition, the ring-shaped conductive pieces 150 need to be rotated by a specific angle and the retaining rod 190 needs to be inserted into the elongated passage 115b of the cylinder 115. That is, the assembling process of the transformer 100 is complicated. Since the ring-shaped conductive pieces 150 are very thin, it is difficult to tightly fix the ring-shaped conductive pieces 150 in the fixing recesses 111 of the cylinder 115. Moreover, the ring-shaped conductive pieces 150 can be only applied in the secondary side of the transformer 100. Since the ring-shaped conductive pieces 150 are separated from the magnetic core assembly 130 by the cylinder 115, the transformer 100 has reduced coupling coefficient and inferior performance.

Referring to FIG. 1(b), a schematic exploded view of another conventional transformer disclosed in U.S. Pat. No. 7,091,817 B2 is illustrated. The transformer of FIG. 1(b) principally comprises a winding member 410, multiple conductive pieces 420, a magnetic core assembly 430 and a primary winding coil (not shown). The winding member 410 includes a tube structure 411, a first partition plate 413 and a second partition plate 414. The first partition plate 413 is parallel with second partition plate 414. A winding section 415 is defined between the first partition plate 413, the second partition plate 414 and the external surface of the tube structure 411. In addition, bending pieces 4131 and 4141 are extended from both edges of the first partition plate 413 and the second partition plate 414, respectively. Accordingly, two guiding slots 416 are formed on opposite sides of the winding member 410 for accommodating corresponding conductive pieces 420 therein. Each conductive piece 420 is U-shaped and includes a hollow portion 421 facing the winding member 410. After the conductive pieces 420 are received in the guiding slots 416 and fixed onto the winding member 410, the conductive pieces 420 are electrically connected to a circuit board (not shown).

Similarly, since the conductive pieces 420 are inserted into the guiding slots 416 with the hollow portion 421 facing the winding member 410, the conductive pieces 420 can be only applied in the secondary side of the transformer 400. Moreover, since the conductive pieces 420 are separated from the magnetic core assembly 430 by the tube structure 411, the transformer 400 also has reduced coupling coefficient and inferior performance.

In views of the above-described disadvantages, the applicant keeps on carving unflaggingly to develop a structure of a transformer according to the present invention through wholehearted experience and research.

### SUMMARY OF THE INVENTION

It is an object of the present invention to provide a transformer, which is simple in the structure, easily assembled and cost-effective.

In accordance with an aspect of the present invention, there is provided a transformer. The transformer includes a primary winding coil, a plurality of conductive pieces, a bobbin and a magnetic core assembly. The bobbin includes a plurality of hollow partition plates and a wall portion. The wall portion is arranged between every two adjacent hollow partition plates to form a channel and a winding section for being wound the primary winding coil thereon. The hollow partition plates have respective receiving portions for accommodating the conductive pieces therein. The magnetic core assembly is partially embedded within the channel.

In accordance with another aspect of the present invention, there is provided a transformer connectable to an electronic component and/or a heat sink. The transformer includes a primary winding coil, a plurality of conductive pieces, a bobbin and a magnetic core assembly. Each of the conductive pieces includes a first extension portion connected to the electronic component and/or the heat sink to facilitate fixture and/or heat dissipation of the electronic component and/or the heat sink. The bobbin includes a plurality of hollow partition plates and a wall portion. The wall portion is arranged between every two adjacent hollow partition plates to form a channel and a winding section for being wound the primary winding coil thereon. The hollow partition plates have respective receiving portions for accommodating the conductive pieces therein. The magnetic core assembly is partially embedded within the channel.

The above contents of the present invention will become more readily apparent to those ordinarily skilled in the art after reviewing the following detailed description and accompanying drawings, in which:

### BRIEF DESCRIPTION OF THE DRAWINGS

FIG. 1(a) is a schematic exploded view of a conventional transformer;

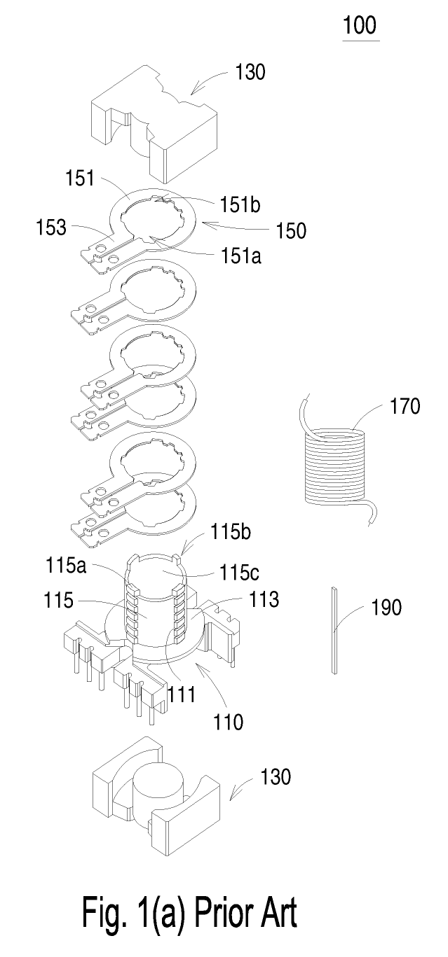

FIG. 1(b) is a schematic exploded view of another conventional transformer;

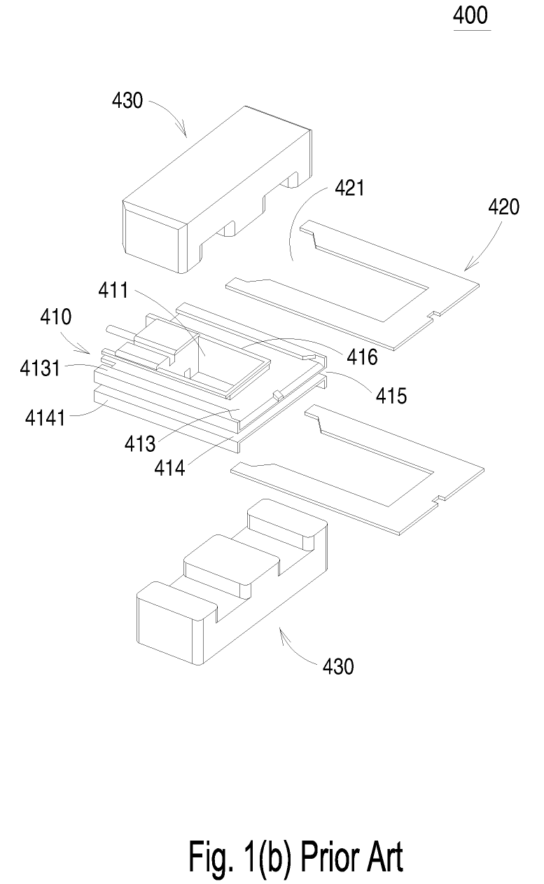

FIG. 2(a) is a schematic exploded view of a transformer according to a first preferred embodiment of the present invention;

FIG. 2(b) is a schematic rear view of the transformer of FIG. 2(a) showing that the primary winding coil is wound around the bobbin;

FIG. 2(c) is a schematic front view of the transformer of FIG. 2(a) showing that the primary winding coil is wound around the bobbin;

FIG. 2(d) is a schematic assembled view of the transformer of FIG. 2(a), which is mounted on a circuit board;

FIG. 3(a) is a schematic exploded view of a transformer according to a second preferred embodiment of the present invention;

FIG. 3(b) is a schematic rear view of the transformer of FIG. 3(a) showing that the primary winding coil is wound around the bobbin;

FIG. 3(c) is a schematic assembled view of the transformer of FIG. 3(a);

FIG. 4(a) is a schematic cross-sectional view illustrating an expanded application of the transformer of FIG. 3(c); and

FIG. 4(b) is a schematic assembled view illustrating an expanded application of the transformer of FIG. 2(d).

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

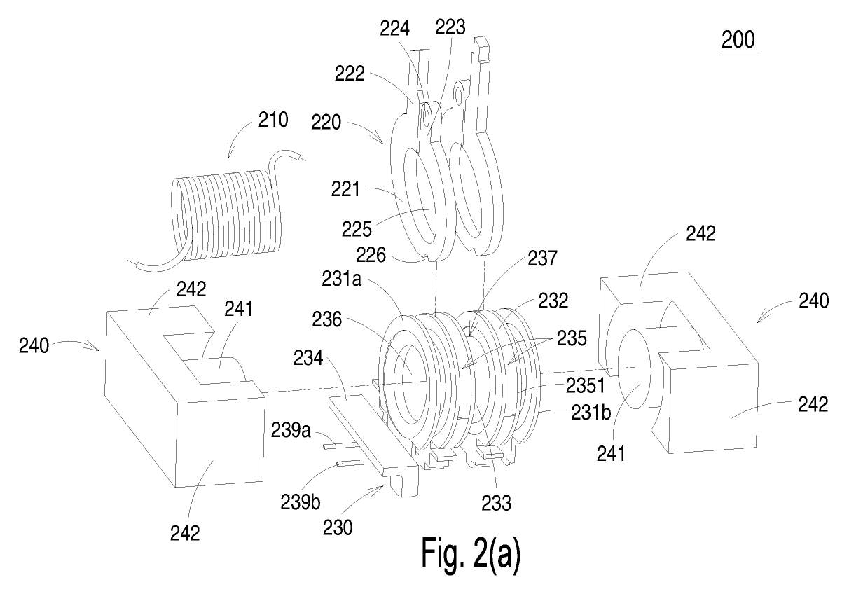

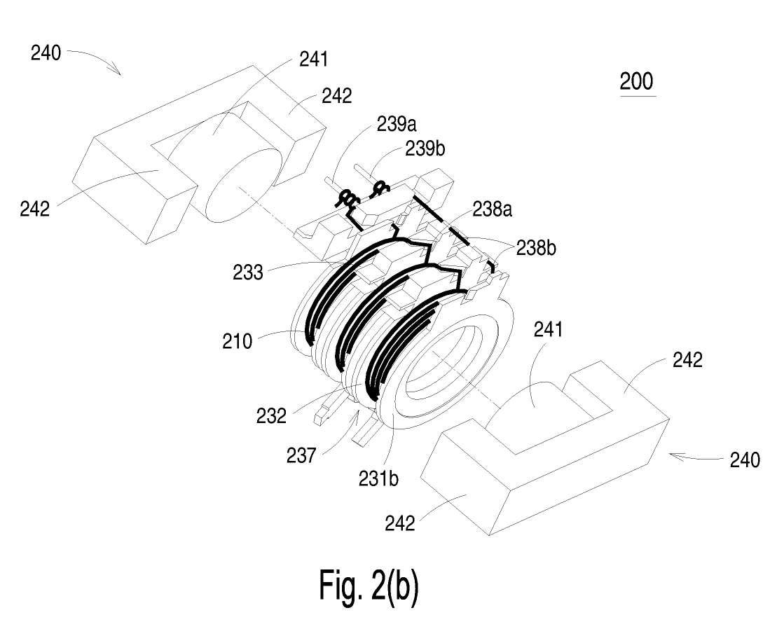

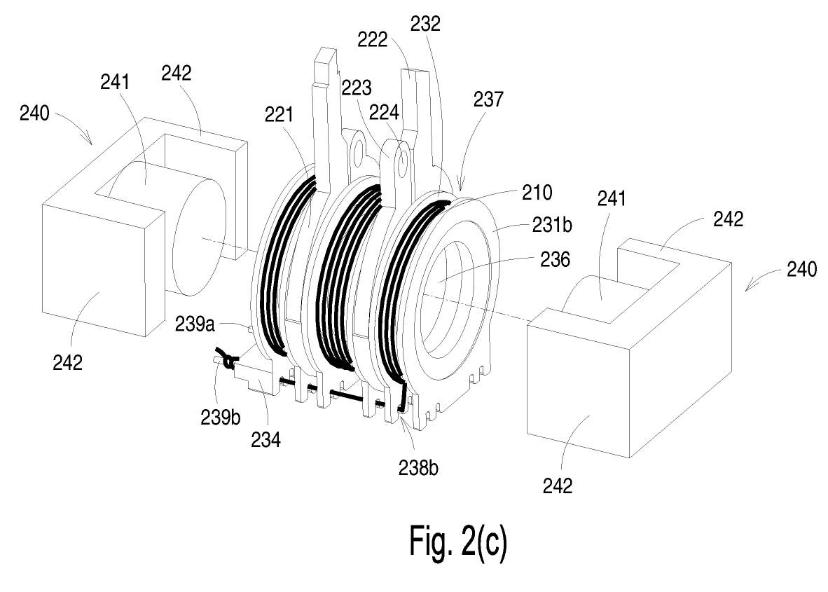

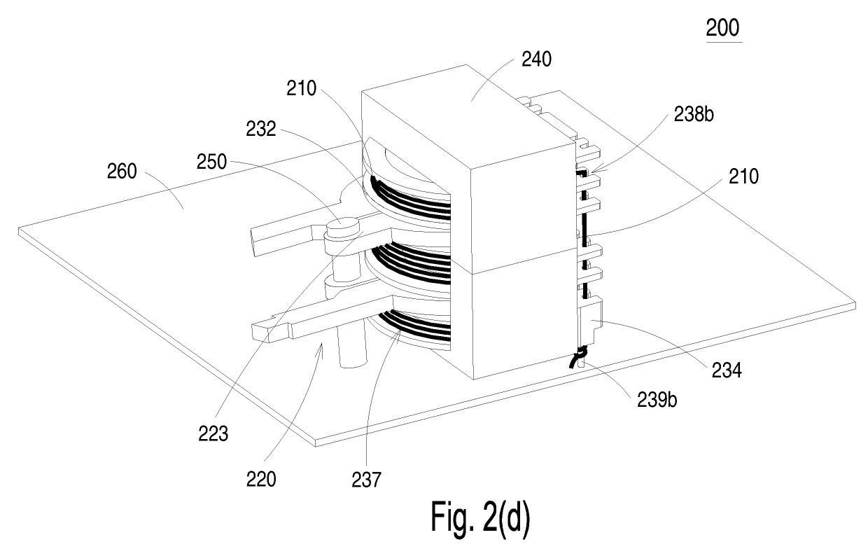

Hereinafter, a process of assembling a transformer according to a first preferred embodiment of the present invention will be illustrated with reference to FIGS. 2(a)-2(d).

As shown in FIGS. 2(a)-2(d), the transformer 200 includes a primary winding coil 210, multiple conductive pieces 220, a bobbin 230 and a magnetic core assembly 240.

In this embodiment, the bobbin 230 comprises two side plates 231a, 231b, multiple hollow partition plates 232, a wall portion 233 and a base 234. The side plates 231a, 231b, the hollow partition plates 232 and the wall portion 233 have cylindrical shapes. The side plates 231a, 231b are arranged on both sides of the bobbin 230 and have apertures therein.

The hollow partition plates 232 are parallel with the side plates 231a, 231b and have respective receiving portions 235. Each receiving portion 235 has an entrance 2351. The cross-sectional length of the entrance 2351 is substantially greater than the diameter of the corresponding conductive piece 220 such that the conductive piece 220 may be inserted into the receiving portion 235 through the entrance 2351. The wall portion 233 is arranged between every two hollow partition plates 232, between the first side plate 231a and the adjacent hollow partition plate 232, and between the second side plate 231b and the adjacent hollow partition plate 232. The wall portion 233 is also in connect with neighboring side plates 231a, 231b and neighboring hollow partition plates 232 so as to form a channel 236 therein. Moreover, one or more winding sections 237 are defined by the side plates 231a, 231b, the hollow partition plates 232 and the wall portion 233, so that the primary winding coil 210 may be wound around the winding sections 237.

Please refer to FIGS. 2(a) and 2(b). A first pin 239a and a second pin 239b are disposed on the base 234. Furthermore, the side plates 231a, 231b, the hollow partition plates 232 and the base 234 have respective first notches 238a and second notches 238b. For winding the primary winding coil 210 on the bobbin 230, a terminal of the primary winding coil 210 is firstly wound around and soldered on the first pin 239a. The primary winding coil 210 is successively wound around the winding sections 237 from the first side plate 231a to the second side plate 231b through the first notches 238a. Subsequently, the primary winding coil 210 is successively received in the second notches 238b from the second side plate 231b to the first side plate 231a. Afterward, the other terminal of the primary winding coil 210 is wound around and soldered onto the second pin 239b of the base 234.

In this embodiment, the magnetic core assembly 240 of the transformer 200 is an EE-type magnetic core assembly and composed of two E-type magnetic cores. Each E-type magnetic core includes a first magnetic part 241 and a second magnetic part 242. Each conductive piece 220 includes a main body 221, a first extension portion 222, a second extension portion 223 and a hollow portion 225. The second extension portion 223 has a perforation 224 therein. The diameter of the hollow portion 225 of the conductive piece 220 is substantially identical to that of the channel 236 of the bobbin 230. After the conductive pieces 220 are inserted into the corresponding receiving portions 235 through the entrances 2351, the hollow portions 225 of the conductive pieces 220 are in communication with the channel 236 of the bobbin 230. Next, the first magnetic parts 241 of the magnetic core assembly 240 are embedded into the channel 236 of the bobbin 230 and the hollow portions 225 of the conductive pieces 220, so that the conductive pieces 220 are fixed onto the bobbin 230. Optionally, the bottom of the conductive piece 220 further includes a retaining part 226 such as an indentation. Once the conductive pieces 220 are inserted into the corresponding receiving portions 235, the retaining parts 226 are engaged with complementary retaining parts (not shown) within the receiving portions 235 so as to facilitate positioning the conductive pieces 220.

The first magnetic parts 241 of the magnetic core assembly 240 are embedded into the channel 236 of the bobbin 230 and the hollow portions 225 of the conductive pieces 220. The second magnetic parts 242 of the magnetic core assembly 240 enclose the bobbin 230, as can be seen in FIGS. 2(c) and 2(d). At the primary side of the transformer 200, the primary winding coil 210 is electrically connected to a circuit board 260 via the first pin 239a and the second pin 239b. At the secondary side of the transformer 200, a conductive rod 250 is penetrated through the perforations 224 of the second extension portions 223 of the conductive pieces 220 and inserted into a hole of the circuit board 260, so that the conductive pieces 220 are electrically connected to the circuit board 260. Under this circumstance, the magnetic core assembly 240 interacts with the primary winding coil 210 and the conductive pieces 220 to achieve the purpose of voltage regulation.

Hereinafter, an embodiment of assembling the transformer 200 will be illustrated as follows. First of all, a terminal of the primary winding coil 210 is firstly wound around and soldered on the first pin 239a. The primary winding coil 210 is successively wound around the winding sections 237 from the first side plate 231a to the second side plate 231b through the first notches 238a. Subsequently, the primary winding coil 210 is successively received in the second notches 238b from the second side plate 231b to the first side plate 231a. After the other terminal of the primary winding coil 210 is wound around and soldered onto the second pin 239b of the base 234, the primary winding coil 210 is fixed on the bobbin 230. Subsequently, one or more conductive pieces 220 are inserted into the corresponding receiving portions 235 through the entrances 2351, so that the hollow portions 225 of the conductive pieces 220 are in communication with the channel 236 of the bobbin 230. Then, the first magnetic parts 241 of the magnetic core assembly 240 are embedded into the channel 236 of the bobbin 230 and the hollow portions 225 of the conductive pieces 220, so that the conductive pieces 220 are fixed onto the bobbin 230. Afterward, the conductive rod 250 is penetrated through the perforations 224 of the second extension portions 223 of the conductive pieces 220 to have the conductive pieces 220 electrically connected to the circuit board 260. As shown in FIG. 2(d), the resulting assembling structure of the transformer 200 is mounted on the circuit board 260.

From the above description, the conductive pieces 220 of the transformer 200 according to the present invention are employed to replace the secondary winding coil used in the conventional transformer. After the primary winding coil 210 is wound around the winding sections 237 of the bobbin 230 and the conductive pieces 220 are fixed onto the bobbin 230, the transformer 200 of the present invention is assembled without difficulty and complexity. As a consequence, the problems occurred in the prior art will be effectively overcome. Moreover, since the receiving portions of the hollow partition plates 232 are in communication with the channel 236 of the bobbin 230, the conductive pieces 220 will be in direct contact with first magnetic parts 241 of the magnetic core assembly 240. As a result, the transformer 200 has increased coupling coefficient and better performance. In addition, for enhancing the heat-dissipating efficiency of the transformer 200, the conductive pieces 220 are preferably made of high thermally conductive material such as copper. Optionally, the side plates 231a, 231b, the hollow partition plates 232, the wall portion 233 and the base 234 of the bobbin 230 are integrally formed.

It is noted that, however, those skilled in the art will readily observe that numerous modifications and alterations of the transformer structure may be made according to the space utilization and the practical requirement.

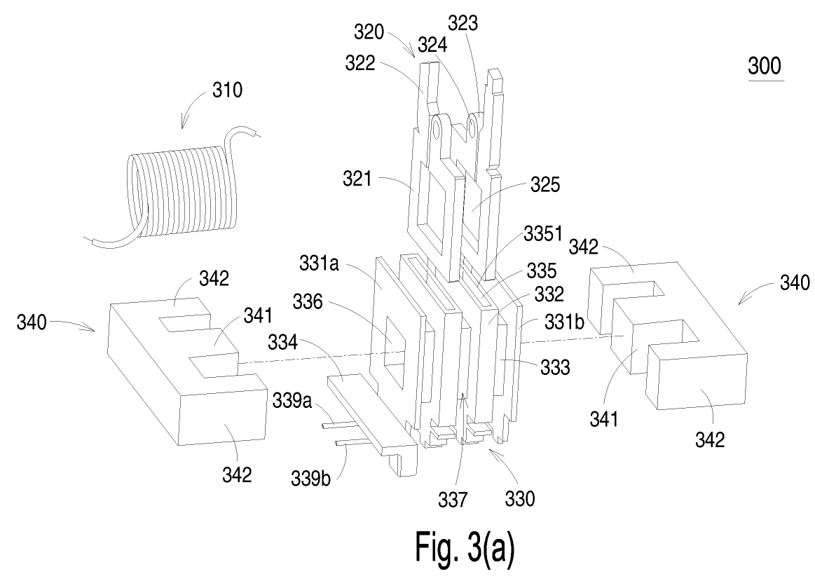

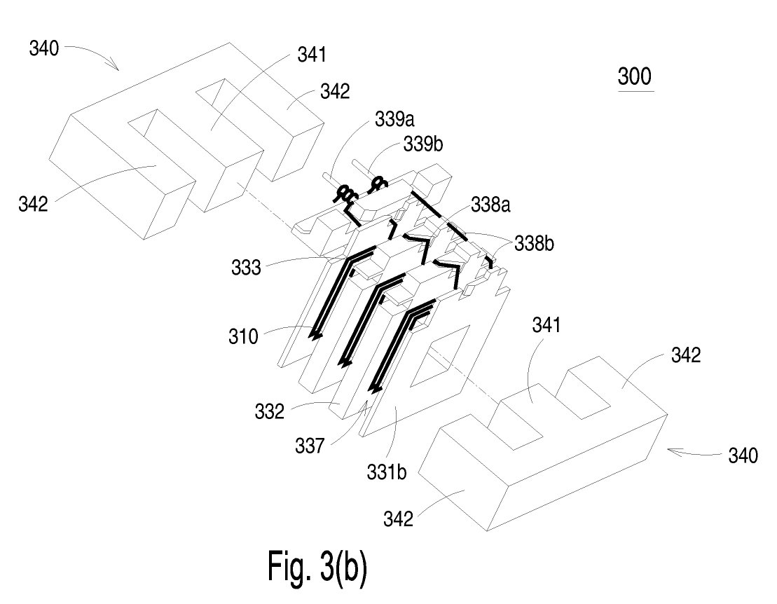

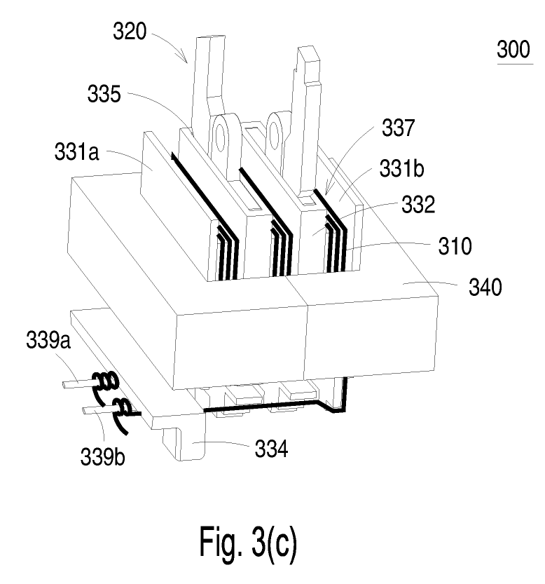

Hereinafter, a process of assembling a transformer according to a second preferred embodiment of the present invention will be illustrated with reference to FIGS. 3(a)-3(c).

As shown in FIG. 3(a), the transformer 300 includes a primary winding coil 310, multiple conductive pieces 320, a bobbin 330 and a magnetic core assembly 340. In comparison with the transformer 200 of FIG. 2(a), the conductive pieces 320 and the bobbin 330 are rectangular in shape.

In this embodiment, each conductive piece 320 includes a main body 321, a first extension portion 322, a second extension portion 323 and a hollow portion 325. The main body 321 and the hollow portion 325 are rectangular in shape. The second extension portion 323 has a perforation 324 therein. The bobbin 330 comprises two side plates 331a, 331b, multiple hollow partition plates 332, a wall portion 333 and a base 334. The side plates 331a, 331b, the hollow partition plates 332 and the wall portion 333 have rectangular shapes. The side plates 331a, 331b are arranged on both sides of the bobbin 330 and have apertures therein. The hollow partition plates 332 are parallel with the side plates 331a, 331b and have respective receiving portions 335. Each receiving portion 335 has an entrance 3351 for inserting corresponding conductive piece 320 therethrough. The magnetic core assembly 340 of the transformer 300 is an EE-type magnetic core assembly and composed of two E-type magnetic cores. Each E-type magnetic core includes a first magnetic part 341 and a second magnetic part 342. The operation principles, locations and structures of the primary winding coil 310, the conductive pieces 320, the bobbin 330 and the magnetic core assembly 340 included therein are similar to those shown in FIG. 2, and are not to be redundantly described herein.

Furthermore, the side plates 331a, 331b, the hollow partition plates 332 and the base 334 have respective first notches 338a and second notches 338b. For winding the primary winding coil 310 on the bobbin 330, a terminal of the primary winding coil 310 is firstly wound around and soldered on the first pin 339a. The primary winding coil 310 is successively wound around the winding sections 337 from the first side plate 331a to the second side plate 331b through the first notches 338a. Subsequently, the primary winding coil 310 is successively received in the second notches 338b from the second side plate 331b to the first side plate 331a. Afterward, the other terminal of the primary winding coil 310 is wound around and soldered onto the second pin 339b of the base 334, as is shown in FIG. 3(b).

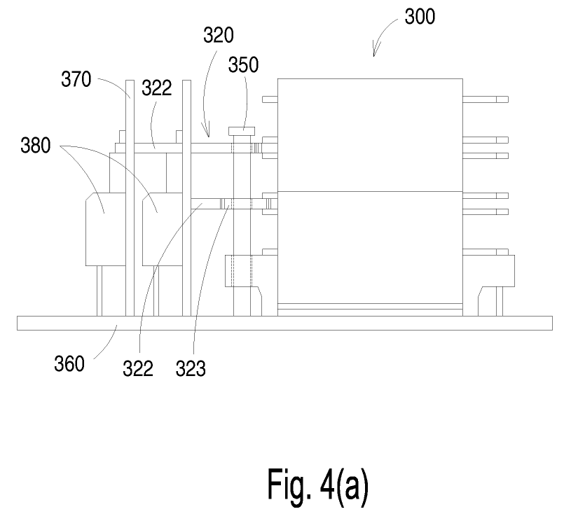

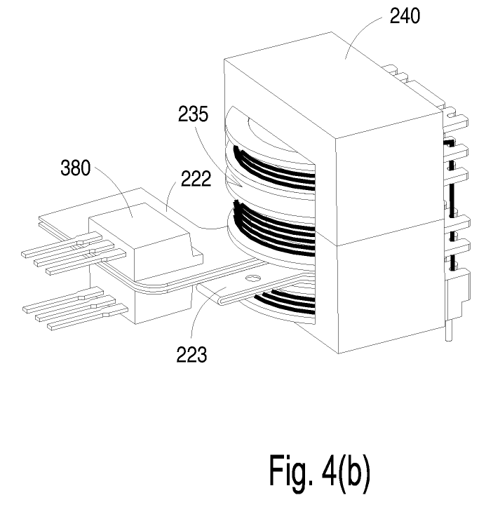

Hereinafter, an embodiment of assembling the transformer 300 will be illustrated as follows. First of all, a terminal of the primary winding coil 310 is firstly wound around and soldered on the first pin 339a. The primary winding coil 310 is successively wound around the winding sections 337 from the first side plate 331a to the second side plate 331b through the first notches 338a. Subsequently, the primary winding coil 310 is successively received in the second notches 338b from the second side plate 331b to the first side plate 331a. After the other terminal of the primary winding coil 310 is wound around and soldered onto the second pin 339b of the base 334, the primary winding coil 310 is fixed on the bobbin 330. Subsequently, one or more conductive pieces 320 are inserted into the corresponding receiving portions 335 through the entrances 3351, so that the hollow portions 325 of the conductive pieces 320 are in communication with the channel 336 of the bobbin 330. Then, the first magnetic parts 341 of the magnetic core assembly 340 are embedded into the channel 336 of the bobbin 330 and the hollow portions 325 of the conductive pieces 320 and the second magnetic parts 342 of the magnetic core assembly 340 enclose the bobbin 330, as can be seen in FIG. 3(c). Afterward, a conductive rod 350 is penetrated through the perforations 324 of the second extension portions 323 of the conductive pieces 320 to have the conductive pieces 320 electrically connected to the circuit board 360, as can be seen in FIG. 4(a).

FIG. 4(a) is a schematic cross-sectional view illustrating an expanded application of the transformer of FIG. 3(c). The applications of the transformer may be expanded via the first extension portion 322 of the conductive piece 320. The first extension portion 322 of the conductive piece 320 is strip-shaped and contacted with one or more heat sinks 370 and/or electronic components 380 (e.g. IC modules). As a consequence, the first extension portion 322 of the conductive piece 320 may facilitate fixture and/or heat dissipation of the heat sinks 370 and/or electronic components 380. Since the fixing elements are reduced, the space utilization of the circuit board 360 is increased.

FIG. 4(b) is a schematic assembled view illustrating an expanded application of the transformer of FIG. 2(d). The applications of the transformer may be expanded via the first extension portion 222 of the conductive piece 220. The first extension portion 222 of the conductive piece 220 is sheet-shaped and contacted with one or more electronic components 380 (e.g. IC modules). As a consequence, the first extension portion 222 of the conductive piece 220 may facilitate fixture and/or heat dissipation of the electronic components 380. Since the fixing elements are reduced, the space utilization of the circuit board 260 is increased. It is noted that, however, those skilled in the art will readily observe that numerous modifications and alterations of the first extension portion may be made while retaining the teachings of the invention. For example, the first extension portion may be directly or indirectly in contact with any heat sink and/or heat-generation component.

From the above description, in the transformer of the present invention, the conductive pieces are employed to replace the secondary winding coil used in the conventional transformer. After the primary winding coil is wound around the winding sections of the bobbin and the conductive pieces are fixed onto the bobbin, the transformer of the present invention is assembled without difficulty and complexity. Moreover, the transformer has increased coupling coefficient and better performance. Since the first extension portion of the conductive piece is optionally contacted with one or more heat sinks and/or electronic components, the heat-efficiency and the space utilization are increased.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A transformer comprising:
a primary winding coil;
a plurality of conductive pieces;
a bobbin including a plurality of hollow partition plates and a wall portion, said wall portion being arranged between every two adjacent hollow partition plates to form a channel and a winding section for being wound said primary winding coil thereon, wherein said hollow partition plates have respective receiving portions for accommodating said conductive pieces therein; and
a magnetic core assembly partially embedded within said channel.

2. The transformer according to claim 1 wherein said conductive pieces are made of copper.

3. The transformer according to claim 1 wherein each of said conductive pieces includes:
a main body including a hollow portion;
a first extension portion coupled to an end of said main body and optionally connected to an electronic component and/or a heat sink; and
a second extension portion coupled to the other end of said main body and including a perforation therein, wherein a conductive rod is penetrated through said perforations of said second extension portions of said conductive pieces and electrically connected to a circuit board.

4. The transformer according to claim 3 wherein said magnetic core assembly are partially embedded within said channel and said hollow portions of said main bodies of said conductive pieces.

5. The transformer according to claim 1 wherein said receiving portion of each hollow partition plate has an entrance, and the cross-sectional length of said entrance is substantially greater than the diameter of said conductive piece such that said conductive piece is inserted into said receiving portion through said entrance.

6. The transformer according to claim 1 wherein said receiving portion of each hollow partition plate is communicated with said channel.

7. The transformer according to claim 1 wherein each hollow partition plate has a notch such that said primary winding coil is successively wound around said winding section through said notch.

8. A transformer connectable to an electronic component and/or a heat sink, said transformer comprising:
a primary winding coil;
a plurality of conductive pieces, each of which includes a first extension portion connected to said electronic component and/or said heat sink to facilitate fixture and/or heat dissipation of said electronic component and/or said heat sink;
a bobbin including a plurality of hollow partition plates and a wall portion, said wall portion being arranged between every two adjacent hollow partition plates to form a channel and a winding section for being wound said primary winding coil thereon, wherein said hollow partition plates have respective receiving portions for accommodating said conductive pieces therein; and
a magnetic core assembly partially embedded within said channel.

9. The transformer according to claim 8 wherein said conductive pieces are made of copper.

10. The transformer according to claim 8 wherein each of said conductive pieces includes:
a main body including a hollow portion; and
a second extension portion coupled to said main body and including a perforation therein, wherein a conductive rod is penetrated through said perforations of said second extension portions of said conductive pieces and electrically connected to a circuit board.

11. The transformer according to claim 10 wherein said magnetic core assembly are partially embedded within said channel and said hollow portions of said main bodies of said conductive pieces.

12. The transformer according to claim 8 wherein said receiving portion of each hollow partition plate has an entrance, and the cross-sectional length of said entrance is substantially greater than the diameter of said conductive piece such that said conductive piece is inserted into said receiving portion through said entrance.

13. The transformer according to claim 8 wherein said receiving portion of each hollow partition plate is communicated with said channel.

14. The transformer according to claim 8 wherein each hollow partition plate has a notch such that said primary winding coil is successively wound around said winding section through said notch.
